(19) United States
(12) Patent Application Publication
(10) Pub. No.: US 2006/0017936 A1
(43) Pub. Date: Jan. 26, 2006

(54) Transparent object height measurement

(76) Inventors: Michel Cantin, Brossard (CA); Alexandre Nikitine, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/895,977

(22) Filed: Jul. 22, 2004

(51) Int. Cl. G01B 11/24

(52) U.S. Cl. 356/604

(57) ABSTRACT

A method and system for determining a height of a substantially transparent object having a refractive index are presented. The method is based on Fast Moiré Interferometry and comprises obtaining at least one image of the object corresponding to an intensity pattern projected on the pellicle. Then the method comprises establishing a phase associated to the object using the image and comprises determining the height using the object phase, the refractive index and a reference phase corresponding to a reference surface.

### FIELD OF THE INVENTION

The invention relates to measurement systems and methods. More specially, the present invention relates to transparent height object measurement based on a Fast Moiré Interferometry method.

### BACKGROUND OF THE ART

In the field of semi-conductor fabrication, the inspection of the quality of the semi-conductor surface, as the different components and circuit layers are added, is very important.

One method that is used to measure the height or thickness of a pellicle deposited on a semi-conductor surface is based on an interferometric method where the variation of a wavelength spectrum is analyzed. In this method, a white light source is projected on the pellicle and a reflected spectrum from the pellicle is measured. The reflected spectrum from the pellicle contains a component which corresponds to the interference between the reflected light at the surface of the pellicle and the reflected light at the interface between the pellicle and the semi-conductor. By comparing this spectrum to a reference spectrum obtained without the pellicle, it is possible to infer the pellicle thickness.

One drawback with this method is that it is based on the spectrum analysis of the light, which involves the use of a spectrum analyzer.

### SUMMARY

The invention provides a method of determining a height of a substantially transparent object having a refractive index. The method comprises obtaining an image of the object corresponding to an intensity pattern projected on the object, establishing a phase associated to the object using the image and determining the height using the object phase, the refractive index and a reference phase. The method further comprises determining an angle between a projection axis, along which is projected said intensity pattern, and a normal axis being substantially normal to a surface of the object. The method comprises determining the height of at least one of a pellicle, a coating, a liquid and a semi-opaque object.

The invention further provides a method of determining a height of a substantially transparent object having a refractive index. The method comprises obtaining at least two images of the object, each image being associated with a corresponding intensity pattern projected on the object, establishing a phase associated to the object using the images and determining the height using the object phase, the refractive index and a reference phase. The method further comprises intensity patterns that are phase-shifted with respect to each others. Also, the method comprises obtaining simultaneously a first and a second image of the object, the first image corresponding to a first bandwidth of a first intensity pattern and the second image corresponding to a second bandwidth of a second intensity pattern.

The invention further provides a method of determining a variation of a height of a substantially transparent object having a refractive index. The method comprises obtaining at least one image of a first layer of the object corresponding to an intensity pattern projected on the first layer and establishing a phase associated to the first object layer using the at least one image of the first layer. The method also comprises obtaining at least one image of a second layer of the object corresponding to an intensity pattern projected on the second layer and establishing a phase associated to the second object layer using the at least one image of the second layer. The method also comprises determining the variation of the height of the object using the phases of the first and second object layers and the refractive index.

The invention further provides a method of determining a presence of a substantially transparent object on at least a part of a reference object. The method comprises obtaining an image of the reference object corresponding to an intensity pattern projected on the reference object and determining the presence of the substantially transparent object by comparing the image to a reference image.

The invention further provides a method of determining a presence of a substantially transparent object on at least a part of a reference object. The method comprises obtaining at least one image of the reference object corresponding to an intensity pattern projected on the reference object, establishing an object phase using the at least one image, and determining the presence of the object by comparing the object phase to a reference phase.

The invention further provides an interferometric system for determining a height of a substantially transparent object having a refractive index. The system comprises a pattern projection assembly for projecting along a projection axis an intensity pattern on the object and a detection assembly for obtaining at least one image of the object. The system also comprises a processor for establishing a phase of the object using the at least one image and for determining the height of the object using the object phase, the refractive index and a reference phase.

### DESCRIPTION OF THE DRAWINGS

In order that the invention may be readily understood, embodiments of the invention are illustrated by way of example in the accompanying drawings.

FIG. 1 is a schematic view of a phase-stepping Fast Moiré Interferometry (FMI) method as known in the prior art;

FIG. 2 is a schematic view of a phase stepping FMI method for measuring a transparent object height in accordance with one embodiment of the present invention;

FIG. 3 is a flow chart of a method to determine an object height in accordance with one embodiment of the present invention;

FIG. 4A is a flowchart of part of the method of FIG. 3 in accordance with an embodiment of the present invention;

FIG. 4B is a flowchart of part of the method of FIG. 3 in accordance with another embodiment of the present invention;

FIG. 5 is a flow chart of a method to determine the presence of a pellicle on an object in accordance with an embodiment of the present invention;

FIG. 6 is a schematic view of the system for determining the transparent object height according to an embodiment of the present invention;

FIG. 7 is a block diagram describing the relations between the system components and a controller according to an embodiment of the present invention; and

FIG. 8 is an example of water drops on a substrate, the shape of which were determined with the present invention.

Further details of the invention and its advantages will be apparent from the detailed description included below.

### DETAILED DESCRIPTION

In the following description of the embodiments, reference to the accompanying drawings are by way of illustration of an example by which the invention may be practiced. It will be understood that other embodiments may be made without departing from the scope of the invention disclosed.

In one embodiment of the present invention, the height of a substantially transparent object such as, for example a pellicle, is measured using a Fast Moiré Interferometry phase stepping method.

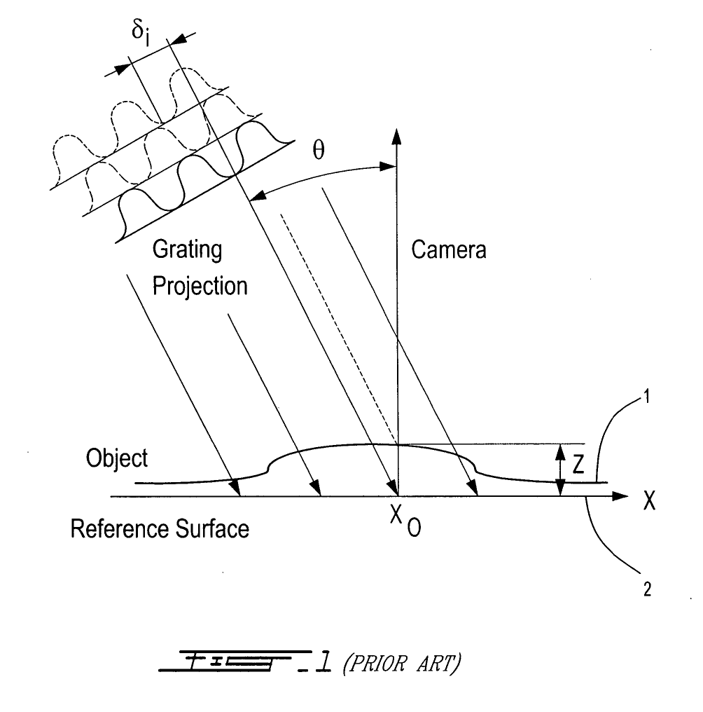

The Fast Moiré Interferometry phase-stepping method (FMI) is based on the combination of structured light projection and phase-shift method for the extraction of 3D information at each point of an image, I(x,y). FIG. 1 presents an example of such a FMI method.

An image is taken of an object and the 3D information is extracted from this image by evaluating an intensity variation at each point of the image due to the height profile of the object. The height profile information of the object, z_{object}(x,y), can be found in the phase map φ_{object}(x,y) associated with the variation of the image intensity, I(x,y). A phase-shifting technique with different images taken for different grating projections is used to determine, from the images, the phase map φ_{object}(x,y) for both the object and for a reference surface φ_{ref}(x,y). As it is well known in the art, depending on the situation, the phase map may be determined with only two images (meaning that there are only two intensity pattern projections, each pattern projections being phase-shifted from the other) or with more than two images (in this case, more phase-shifted projections of the intensity pattern are needed).

Once the object and reference phase maps have been determined, the height profile of the object relative to the reference surface, h(x,y)=z_{object}(x,y)−z_{ref}(x,y) is calculated on the basis of the difference of the phase values, δ(x,y), for each point of the image:
h(x,y)=z_{object}(x,y)−z_{ref}(x,y) [symbol] δ(x,y)=φ_{object}(x,y)−φ_{ref}(x,y)

Thus, the FMI method offers the possibility to measure a solid object height versus any reference surface. For example, it could be a plane reference, or a model object without any defects.

As described in the following, the FMI method may be also applied to determine the height or thickness of a substantially transparent object such as, for example a pellicle, a coating, a liquid, a semi-opaque object, or any other substantially transparent matter.

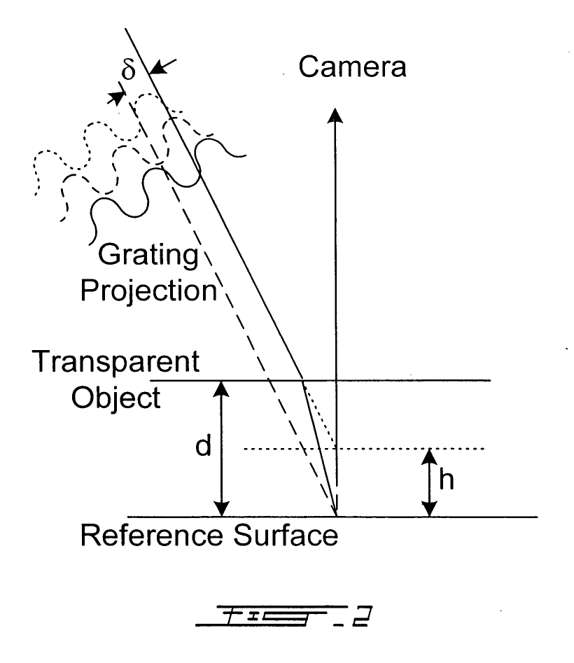

FIG. 2 presents an example of the FMI method applied in that case to measure the thickness. “d” of a transparent object such as a pellicle deposited on a reference surface. An intensity pattern, such as for example a grating pattern or a sinusoidal pattern, is projected along a projection axis on the transparent object. The projection axis makes an angle θ with the normal of the surface of the object. A camera measures, along a detection axis (which is in this particular example also parallel to the normal of the surface), an image of the transparent object corresponding to the first projection of the intensity pattern. This image corresponds to the intensity pattern that has been first refracted by the transparent object and then reflected back at interface of the object and the reference surface.

Then, the projection of the intensity pattern on the transparent object is phase-shifted and another image is taken. This sequence of measurements is repeated until enough images are acquired. From these images, a phase map of the object φ_{object}(x,y) is calculated and, as mentioned above, when the phase map is compared to a reference phase map, φ_{ref}(x,y), a height profile h(x,y) can be determined. As illustrated on FIG. 2, this height profile does not correspond directly to the transparent object height but to the height of a virtual object having a relief producing the same image than the object of thickness “d” on the reference surface.

By knowing the angle θ (the angle between the projection axis and the normal of the surface of the object) and the transparent object refraction index, “n”, it is possible to measure the object thickness “d”. Indeed, because of the presence of the transparent object, the measured phase difference δ(x,y) is equivalent to the presence of a virtual solid object having a height “h”.

The person with knowledge in the art can find the relationship between “d” and “h” on the basis of the projection angle, θ, and the object refraction index, n.

As it will be obvious for someone skilled in the art, the transparent object only need to be substantially transparent. The present method can thus be applied to many type of objects such as semi-opaque objects, pellicle, films, liquids, and so on.

Although we described in the above embodiment a Fast Moiré Interferometry method based on phase-shifting (or phase-stepping) of an intensity pattern, it will be obvious for someone skilled in the art, that other ways, without departing from the scope of the invention disclosed, can be used to extract, from an image, the phase map information, such as for example to use of Fast Fourier Transform to determine the phase map of the transparent object. The present invention comprises all techniques by which the height information of a transparent object can be extracted from one or more images, the images being characterizing the object on which is projected a structured intensity (intensity patterns).

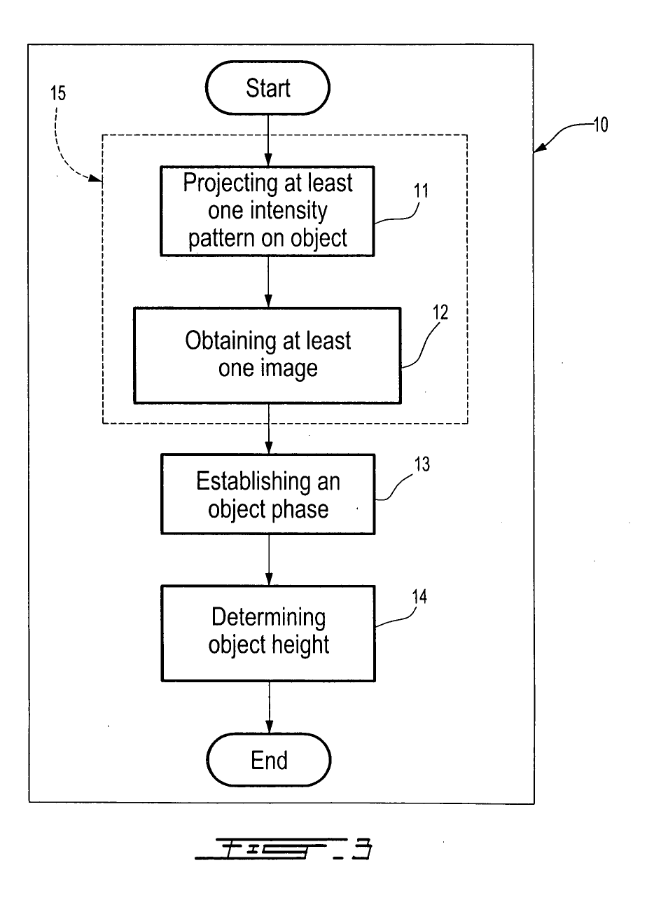

According to an embodiment of the present invention, a method 10 of determining a height of a substantially transparent object, as illustrated in FIG. 3, will be described. At least one intensity pattern is projected on the object (step 11) and at least one image is acquired (step 12). Then an object phase map, φ_{object}(x,y), is determined at step 13 using the acquired images at step 12. By comparing the object phase map φ_{object}(x,y) to a reference phase map φ_{ref}(x,y) corresponding to a reference surface, and knowing the refractive index value of the object, the object height is determined at step 14.

The height can be a measurement of the height at one or several points of the object surface, it can be a measurement along a cross-section line of the object, or it can correspond to a map of the entire object thickness.

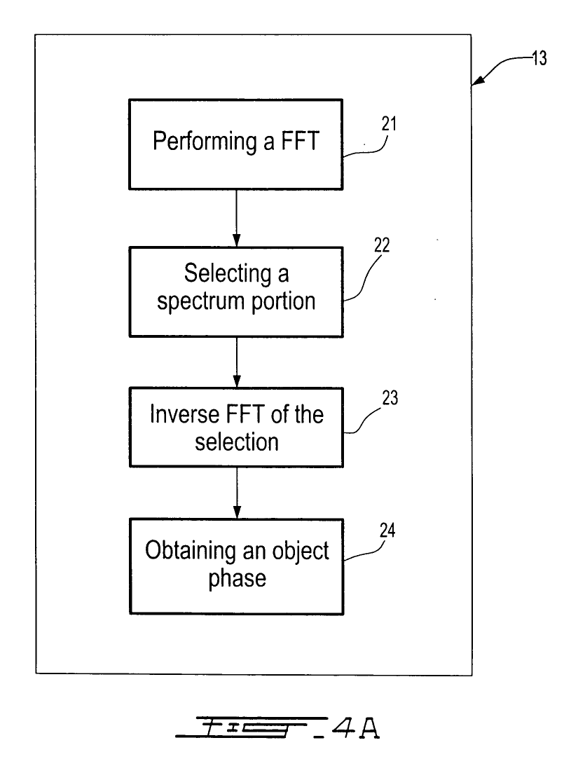

FIG. 4B describes in more detail steps 11 and 12 when a phase-stepping method with only two phase-shifted patterns projections are used to determine the object phase map φ_{object}(x,y). A first image (step 25) is obtained corresponding to a first intensity pattern projection (step 11), then the intensity pattern is phase-shifted (step 26) before a second image is obtained (step 27).

FIG. 4A describes in more details how to determined the object phase map (step 13) when an FFT method is used. In step 21, an FFT is performed using the intensity values of an image acquired in step 12. This provides a spectrum from which a portion is selected (step 22). Then an inverse FFT is performed on the selected portion of the spectrum (step 23). This provides imaginary and real components from which the object phase map φ_{object}(x,y) is established.

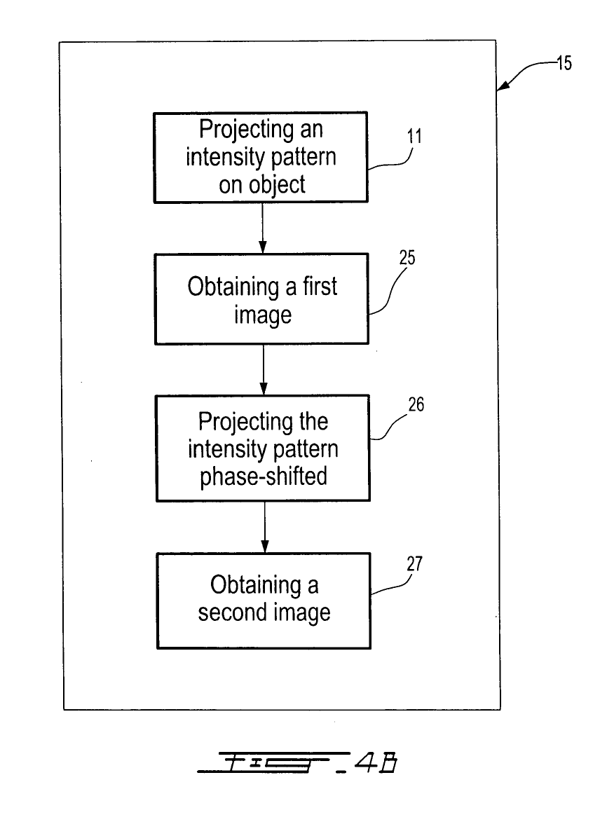

Turning now to FIG. 5, a method 70 of determining the presence of a substantially transparent object such as, for example, a pellicle on an object, will be described. First, an intensity pattern is projected on the object susceptible to be coated by a pellicle (step 71) Then, an image is acquired (step 72). This image is compared to a reference image corresponding to the object with no pellicle and obtained under same intensity pattern projection condition, to verify if the image is deformed in comparison with the reference image (step 73). If it is the case, then it is acknowledged that a pellicle is present (step 75). If no deformation is found, then no pellicle is present on the object (step 74).

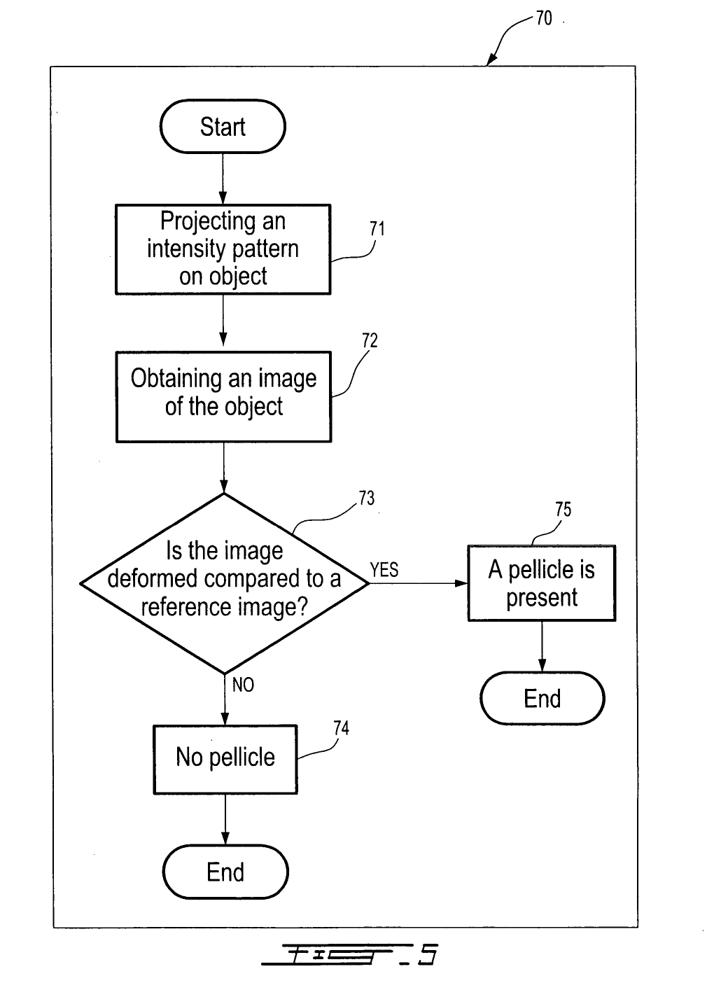

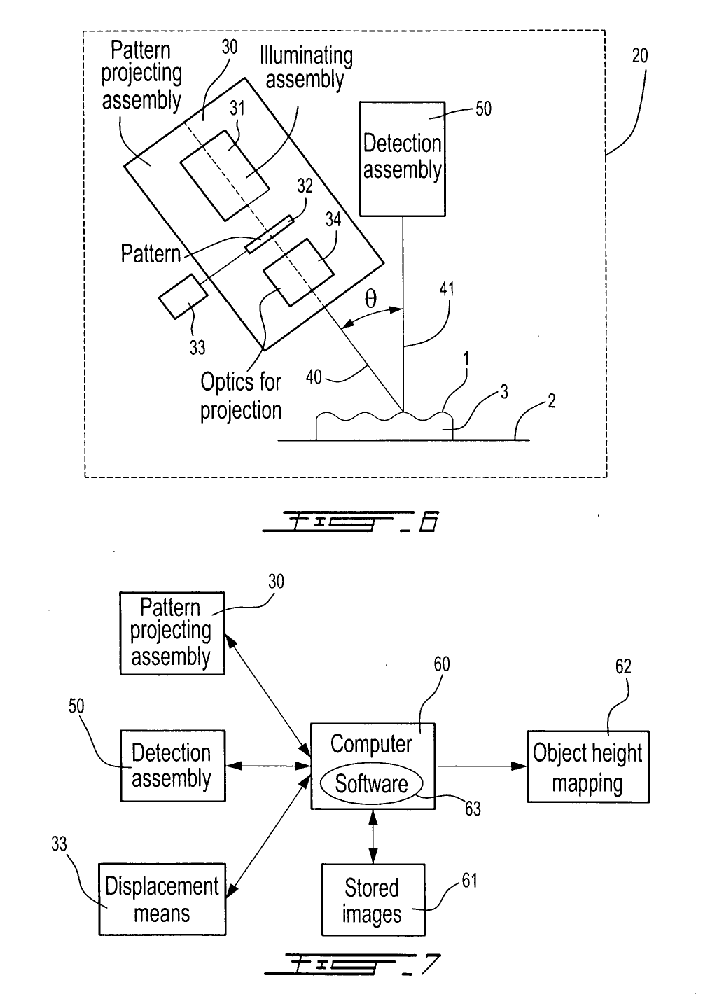

Turning now to FIGS. 6 and 7, a system 20 for determining a height of a substantially transparent object, according to an embodiment of the present invention, is shown. In FIG. 6, a pattern projection assembly 30 is used to project onto the surface 1 of the object 3, on which a pellicle (or any transparent object) has been previously deposited, an intensity pattern. A detection assembly 50 is used to acquire images of the object. The detection assembly 50 can comprise a CCD camera or any other detection device. The detection assembly 50 can also comprise the necessary optical components known to those skilled in the art to relay appropriately the projected intensity pattern on the object to the detection device. The pattern projection assembly 30 is projecting the intensity pattern along a projection axis that makes an angle θ with respect to the normal of the surface of the object. In this particular embodiment, the detection axis 41 of the detection assembly coincides with the normal of the surface of the object. The pattern projection assembly can comprise, for example, an illuminating assembly 31, a pattern 32, and optics for projection 34. The pattern 32 is illuminated by the illuminating assembly 31 and projected onto the object 3 by means of the optics for projection 34. The pattern can be a grid having a selected pitch value, p. Persons skilled in the art will appreciate that other kinds of patterns may also be used. The characteristics of the intensity pattern can be adjusted by tuning both the illuminating assembly 31 and the optics for projection 34. The pattern displacement means 33 is used to shift, in a controlled manner, the pattern relatively to the object. The displacement can be provided by a mechanical device or could also be performed optically by translating the pattern intensity. This displacement can be controlled by a computer 60. Variants means for shifting the pattern relative to the object include displacement of the object 3 and displacement of the pattern projection assembly 30.

As illustrated in FIG. 7, the computer 60 can also control the alignment and magnification power of the pattern projection assembly and the alignment of the detection assembly 50. Naturally the computer 60 is used to compute the object height from the data acquired by the detection assembly 50. The computer 60 is also used to store acquired images and corresponding phase values 61, and manage them. A software 63 can act as an interface between the computer and the user to add flexibility in the system operation.

The software 63 comprises the necessary algorithms to extract from the acquired images the object phase. If this information is extracted by using a FFT processing of the images, then software 63 will include a processing module comprising a FFT algorithm to perform a FFT on an image an provide a spectrum, a selection algorithm to select automatically a portion of the spectrum, an inverse FFT algorithm to perform an inverse FFT on the selected portion of the spectrum, and an algorithm to extract, from the imaginary and real components resulting from the inverse FFT, the phase map.

The above-described method 10 and system 20 can be used to map the thickness of a transparent object deposited on a reference object or that is above the reference object. They may also be provided for detecting defects on an pellicle in comparison with a similar coated object used as a model or to detect changes of a coated object surface with time. In all cases, the above-described method 10 and system 20 can further include the selection of an appropriate intensity pattern and of an appropriate acquisition resolution that will be in accordance with the thickness of the pellicle or with the height of the transparent object to be measured.

The above-described method 10 can naturally be applied in discrete steps in order to perform the pellicle thickness measurement or the object height measurement layer by layer. This technique—also called image unwrapping—enables one to measure the net transparent object height while keeping a good image resolution.

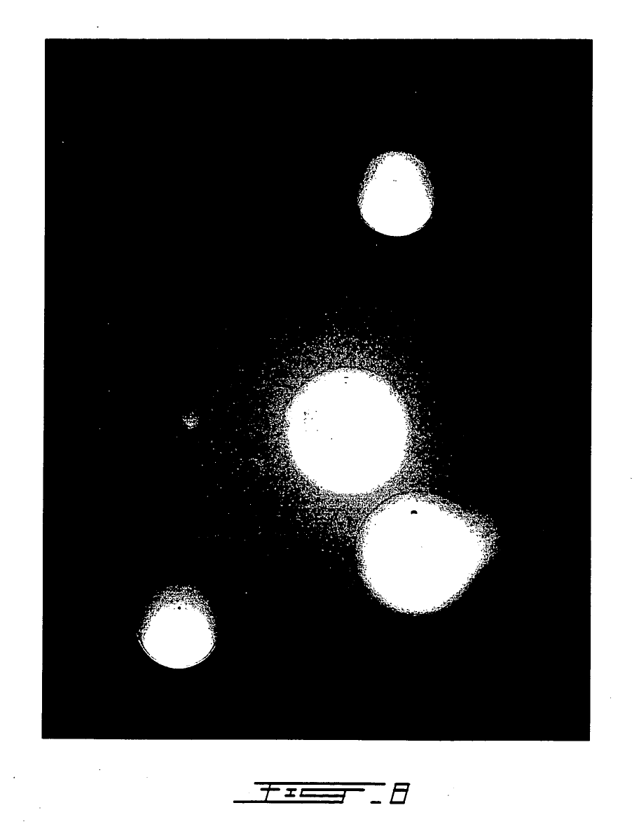

As mentioned earlier, the present method 10 and system 20 can be used to determine the height map of substantially transparent objects of different natures. The substantially transparent object may be a solid coating as well as a liquid object. FIG. 8 gives an example of a height map of water drops on a substrate obtained using the above-described method 10 and system 20.

The above-described method 10 and system 20 can also be used to determine the shape and the volume of an object or of a portion of an object, since this method provides information, not only about the height of the object, but also about its length and width. This method can be advantageously applied, for example, in the semiconductor industry.

All the above presented applications of the invention can be used to further assess the quality of a coated object under inspection.

Although the present invention has been described hereinabove by way of specific embodiments thereof, it can be modified, without departing from the spirit and nature of the subject invention as defined herein.

Although the above description relates to a specific preferred embodiment as presently contemplated by the inventor, it will be understood that the invention in its broad aspect includes mechanical and functional equivalents of the elements described herein.

I claim:

1. A method of determining a height of a substantially transparent object having a refractive index, the method comprising:
obtaining an image of the object corresponding to an intensity pattern projected on the object;
establishing a phase associated to the object using said image; and
determining said height using said object phase, said refractive index and a reference phase.

2. The method as claimed in claim 1, wherein said substantially transparent object comprises at least one of a pellicle, a coating, a liquid and a semi-opaque object.

3. The method as claimed in claim 1, wherein obtaining an image comprises determining an angle between a projection axis, along which is projected said intensity pattern, and a normal axis being substantially normal to a surface of the object, wherein said determined angle is used in the determination of the height of said object.

4. The method as claimed in claim 3, wherein establishing a phase associated to the object comprises:
performing a Fast Fourier Transform (FFT) of said image for providing a spectrum;
performing an inverse FFT of a selected portion of said spectrum for providing imaginary and real components; and
obtaining the object phase using said imaginary and real components.

5. The method as claimed in claim 4, wherein said height comprises a height map of the object and wherein said establishing a phase associated to the object comprises establishing an object phase map.

6. The method as claimed in claim 5, wherein said intensity pattern comprises a sinusoidal pattern.

7. The method as claimed in claim 6, wherein said intensity pattern comprises visible light intensity.

8. The method as claimed in claim 7, wherein at least a part of said object is on a surface of a reference object, wherein said reference phase comprises a reference phase map, and further comprising obtaining at least one image of the reference object corresponding to said intensity pattern projected on the reference object to thereby determine said reference phase map.

9. The method as claimed in claim 7, wherein at least a part of said object is not in contact with a surface of a reference object, wherein said reference phase comprises a reference phase map, and further comprising obtaining at least one image of the reference object corresponding to said intensity pattern projected on the reference object to thereby determine said reference phase map.

10. The method as claimed in claim 7, wherein said object is on a first portion of a surface of a reference object and wherein said reference phase comprises a reference phase map determined by extrapolating, to the first portion, an object reference phase corresponding to a second portion of the surface of the reference object.

11. The method as claimed in claim 10, further comprising obtaining at least one image of the second portion of the reference object corresponding to said intensity pattern projected on said reference object to thereby determine said reference phase map.

12. The method as claimed in claim 10, further comprising evaluating a shape of said object using said height.

13. The method as claimed in claim 12, further comprising evaluating a volume of said shape.

14. The method as claimed in claim 13 wherein said substantially transparent object comprises at least one of a pellicle, a coating, a liquid and a semi-opaque object.

15. A method of determining a height of a substantially transparent object having a refractive index, the method comprising:
obtaining at least two images of the object, each image being associated with a corresponding intensity pattern projected on the object;
establishing a phase associated to the object using said images; and
determining said height using said object phase, said refractive index and a reference phase.

16. The method as claimed in claim 15, wherein said substantially transparent object comprises at least one of a pellicle, a coating, a liquid and a semi-opaque object.

17. The method as claimed in claim 15, wherein obtaining an image comprises determining an angle between a projection axis, along which is projected said intensity pattern, and a normal axis being substantially normal to a surface of the object, wherein said determined angle is used in the determination of the height of said object.

18. The method as claimed in claim 17, wherein intensity patterns comprise intensity patterns that are phase-shifted with respect to each others.

19. The method as claimed in claim 18, comprising obtaining simultaneously a first and a second image of the object, the first image corresponding to a first bandwidth of a first intensity pattern and the second image corresponding to a second bandwidth of a second intensity pattern.

20. The method as claimed in claim 19, wherein said intensity patterns comprises a sinusoidal pattern.

21. The method as claimed in claim 20, wherein said intensity patterns comprises visible light intensity.

22. The method as claimed in claim 21, wherein at least a part of said object is on a surface of a reference object, wherein said reference phase comprises a reference phase map, and further comprising obtaining at least one image of the reference object corresponding to said intensity pattern projected on the reference object to thereby determine said reference phase map.

23. The method as claimed in claim 21, wherein at least a part of said object is not in contact with a surface of a reference object, wherein said reference phase comprises a reference phase map, and further comprising obtaining at least one image of the reference object corresponding to said intensity pattern projected on the reference object to thereby determine said reference phase map.

24. The method as claimed in claim 21, wherein said object is on a first portion of a surface of a reference object and wherein said reference phase comprises a reference phase map determined by extrapolating, to the first portion, an object reference phase corresponding to a second portion of the surface of the reference object.

25. The method as claimed in claim 24, further comprising obtaining at least one image of the second portion of the reference object corresponding to said intensity pattern projected on said reference object to thereby determine said reference phase map.

26. The method as claimed in claim 24, further comprising evaluating a shape of said object using said height.

27. The method as claimed in claim 26, further comprising evaluating a volume of said shape.

28. The method as claimed in claim 27 wherein said substantially transparent object comprises at least one of a pellicle, a coating, a liquid and a semi-opaque object.

29. A method of determining a variation of a height of a substantially transparent object having a refractive index, the method comprising:
obtaining at least one image of a first layer of the object corresponding to an intensity pattern projected on said first layer;
establishing a phase associated to the first object layer using said at least one image of the first layer;
obtaining at least one image of a second layer of the object corresponding to an intensity pattern projected on said second layer;
establishing a phase associated to the second object layer using said at least one image of the second layer; and
determining the variation of the height of said object using the phases of the first and second object layers and said refractive index.

30. The method as claimed in claim 29, wherein said substantially transparent object comprises at least one of a pellicle, a coating, a liquid and a semi-opaque object.

31. The method as claimed in claim 29, wherein obtaining said images comprises determining an angle between a projection axis, along which is projected said intensity patterns, and a normal axis being substantially normal to a surface of the object, wherein said determined angle is used in the determination of the height variation of said object.

32. A method of determining a presence of a substantially transparent object on at least a part of a reference object, the method comprising:
obtaining an image of the reference object corresponding to an intensity pattern projected on the reference object; and
determining the presence of the substantially transparent object by comparing said image to a reference image.

33. The method as claimed in claim 32, wherein said substantially transparent object comprises at least one of a pellicle, a coating, a liquid and a semi-opaque object.

34. The method as claimed in claim 32, further comprising acknowledging an image deformation between the image and the reference image.

35. The method as claimed in claim 34, wherein said reference image corresponds to the intensity pattern projected on the reference object without the presence of the transparent object.

36. The method as claimed in claim 35, wherein at least a part of said object is not in contact with a surface of the reference object.

37. The method as claimed in claim 34, wherein said object is on a first portion of a surface of the reference object and wherein said reference image comprises an extrapolated image, to the first portion, of an image corresponding to a second portion of the surface of the reference object.

38. The method as claimed in claim 37, wherein said image corresponding to a second portion of the surface of the object is obtained with said intensity pattern projected on the reference object.

39. A method of determining a presence of a substantially transparent object on at least a part of a reference object, the method comprising:
obtaining at least one image of the reference object corresponding to an intensity pattern projected on the reference object;
establishing an object phase using said at least one image; and
determining the presence of the object by comparing said object phase to a reference phase.

40. The method as claimed in claim 39, wherein said substantially transparent object comprises at least one of a pellicle, a coating, a liquid and a semi-opaque object.

41. The method as claimed in claim 39, wherein said reference phase is determined by obtaining at least one image of the reference object corresponding to said intensity pattern projected on the reference object without the presence of the transparent object.

42. The method as claimed in claim 41, wherein at least a part of said object is not in contact with a surface of a reference object.

43. The method as claimed in claim 40, wherein said object is on a first portion of a surface of the reference object and wherein said reference phase comprises a reference phase map determined by extrapolating, to the first portion, an object reference phase corresponding to a second portion of the surface of the reference object.

44. The method as claimed in claim 43, further comprising obtaining at least one image of the second portion of the reference object corresponding to said intensity pattern projected on said reference object to thereby determine said reference phase map.

45. An interferometric system for determining a height of a substantially transparent object having a refractive index, the system comprising:
a pattern projection assembly for projecting an intensity pattern on the object;
a detection assembly for obtaining at least one image of the object; and
a processor for establishing a phase of the object using said at least one image and for determining the height of said object using said object phase, said refractive index and a reference phase.

46. The system as claimed in claim 45, wherein said pattern projection assembly projects said intensity pattern along a projection axis making a determined angle with a normal axis being substantially normal to a surface of the object, wherein said determined angle is used in the determination of the height of said object.

47. The system as claimed in claim 46, wherein said pattern projection assembly comprises an illuminating assembly, a pattern, and optical elements for providing said intensity pattern.

48. The system as claimed in claim 47 wherein said detection assembly comprises a detection device and optical devices for acquiring said image characterizing said the object.

49. The system as claimed in claim 48, wherein said detection assembly comprises a CCD camera.

50. The system as claimed in claim 48 further comprising displacement means for positioning, at selected positions, said intensity pattern relative to said object.

51. The system as claimed in claim 50, wherein said processor further comprises a controller to control one of at least the projection assembly, the detection assembly and the displacement means.

52. The system as claimed in claim 51, wherein said controlling comprises controlling said displacement means such that a first image is obtained at a first projection of the intensity pattern and the second image is obtained at a second projection of the intensity pattern, said second projection being phase-shifted relative to the first projection.

53. The system as claimed in claim 48 wherein said processor comprises a Fast Fourier Transform software for establishing the object phase.

54. The system as claimed in claim 48, wherein:
said pattern projection assembly comprises an assembly for simultaneously projecting at least two-phase-shifted intensity patterns on the object, each of the projected patterns being characterized by a predetermined bandwidth; and wherein
said detection assembly comprises an image acquisition apparatus sensitive to said predetermined bandwidths for simultaneously taking an image of each projected patterns on the object.
